(19) United States
(12) Patent Application Publication
(10) Pub. No.: US 2010/0302369 A1
(43) Pub. Date: Dec. 2, 2010

(54) SECURITY SYSTEM WITH SATELLITE SURVEILLANCE UNITS

(76) Inventor: MICHAEL G. MONSIVE, JR., Cypress, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/476,047

(22) Filed: Jun. 1, 2009

(51) Int. Cl. H04N 7/20; G08B 13/18; H04N 5/222; H04N 5/33

(52) U.S. Cl. 348/148; 348/143; 348/E07.093; 348/164; 340/555; 348/E05.09; 348/E05.022

(57) ABSTRACT

A security system suitable for surveying remote installations or sites containing obstacles is provided. The security system may also be well suited for surveying large areas or focusing in on certain spots in an area to be surveyed. The security system may comprise one or more satellite surveillance units (also called surveillance peripherals or simply satellite units) and a main server unit (also called a main unit). The satellite surveillance units may be deployed in a manner that may facilitate monitoring of locations on such sites that a single surveillance unit, even one comprising several surveillance devices, may not be able to monitor due to the presence of obstacles obscuring or blocking the lines of sight of the surveillance devices. The satellite surveillance units may transmit the results of the monitoring to the main server unit, and the main server unit may receive, process and/or store these results.

### BACKGROUND OF THE INVENTION

1. Field of the Invention

Embodiments of the present invention generally relate to surveillance systems and, more particularly, to surveillance systems with one or more satellite surveillance units.

2. Description of the Related Art

Security systems have found applications in various areas. Homes, warehouses, retail stores, construction sites, banks, automated teller machines (ATMs), etc., all use security systems. Deployment of security systems may help detect and/or prevent intrusions, theft, vandalism and other mishaps.

Security systems may be used to monitor remote installations, sites, etc., where vandalism or theft may be common. Such security systems may comprise surveillance equipment like cameras, video recorders, and infrared devices to collect data about the remote installation or site.

A surveillance device like a video camera, while in operation, may not be able to see beyond an obstacle that obscures or blocks the line of sight of the surveillance device. Therefore, security systems employing such surveillance devices may not effectively monitor a remote installation or site containing obstacles (e.g., a construction site with unfinished buildings, construction equipment, fences, trees, vehicles, etc.) if these obstacles block the lines of sight of the surveillance devices. As a result, criminal activities occurring behind such obstacles may go undetected.

Accordingly, what is needed are techniques and apparatus for surveying locations containing obstacles that may obscure the lines of sight of surveillance devices deployed at such locations.

### SUMMARY OF THE INVENTION

One embodiment of the present invention provides a system for surveillance. The system generally includes a main unit and one or more satellite units. The main unit typically includes a receiver and a data processing unit configured to process signals received by the receiver. At least one of the satellite units generally includes a pole, satellite surveillance equipment mounted on the pole, and a transmitter configured to transmit signals from the satellite surveillance equipment to the receiver of the main unit for processing.

Another embodiment of the present invention provides a system for surveillance, which typically includes a main unit and one or more satellite units. The main unit generally includes a pole, local surveillance equipment mounted on the pole, a receiver, and a data processing unit configured to process signals from the local surveillance equipment and signals received by the receiver. Each of the satellite units generally includes satellite surveillance equipment and a transmitter configured to transmit signals from the satellite surveillance equipment to the receiver of the main unit, wherein the data processing unit of the main unit is configured to process the signals from the satellite surveillance equipment.

### BRIEF DESCRIPTION OF THE DRAWINGS

A more particular description of the invention, briefly summarized above, may be had by reference to the embodiments thereof which are illustrated in the appended drawings. It is to be noted, however, that the appended drawings illustrate only typical embodiments of the invention and are, therefore, not to be considered limiting in its scope, for the invention may admit to other equally effective embodiments.

FIG. 1 illustrates a security system deployed at a construction site in accordance with certain embodiments of the present disclosure.

FIG. 2 illustrates an example satellite surveillance unit in accordance with certain embodiments of the present disclosure.

FIG. 3 illustrates a main server unit in accordance with certain embodiments of the present disclosure.

FIG. 4 illustrates example operations for monitoring a remote installation or site in accordance with certain embodiments of the present disclosure.

### DETAILED DESCRIPTION

Certain embodiments of the present disclosure may provide a security system suitable for surveying remote installations or sites containing obstacles. The security system may also be well-suited for surveying large areas or focusing in on certain spots in an area to be surveyed. The security system may comprise one or more satellite surveillance units (also called surveillance peripherals or simply satellite units) and a main server unit (also called a main unit). The satellite surveillance units may be deployed in a manner that may facilitate monitoring of locations on such sites that a single surveillance unit, even one comprising several surveillance devices, may not be able to monitor due to the presence of obstacles obscuring or blocking the lines of sight of the surveillance devices. The satellite surveillance units may transmit the results of the monitoring to the main server unit, and the main server unit may receive, process and/or store these results.

### An Example Security System with Satellite Surveillance Units

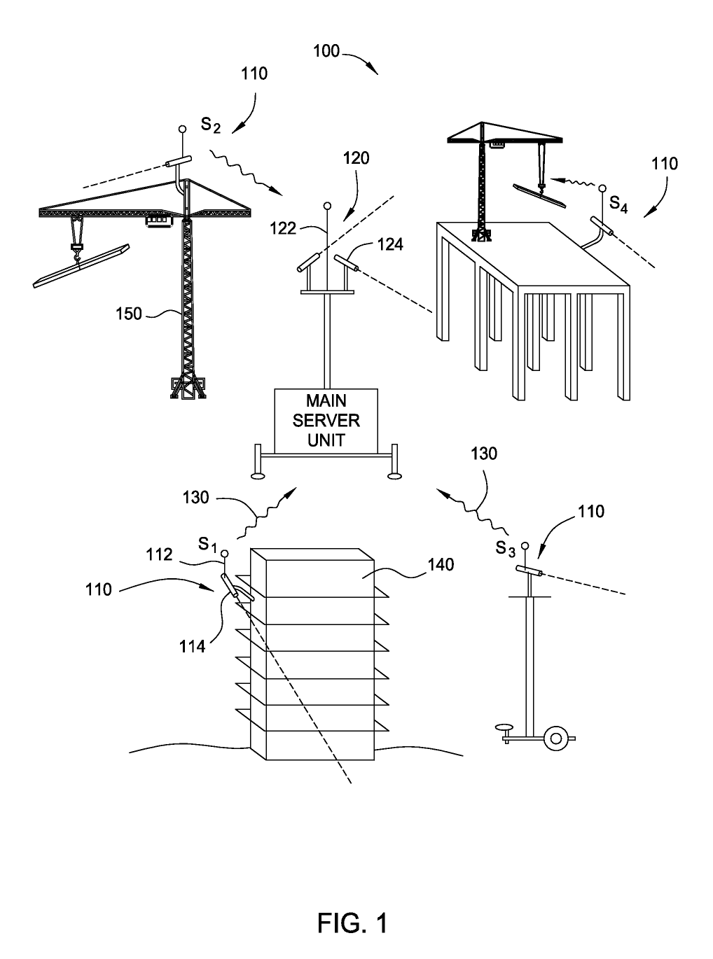

FIG. 1 shows a security system 100 deployed at a construction site according to some embodiments of the present disclosure. As illustrated in FIG. 1, the security system may comprise one or more satellite surveillance units 110 and a main server unit 120.

A satellite surveillance unit 110 may comprise means for monitoring a location and at least part of the surrounding area. The means for monitoring may comprise one or more surveillance devices 114 or other suitable equipment. The surveillance devices 114 may comprise one or more cameras, for instance. A variety of cameras may be used as the surveillance devices 114. For example, some embodiments may use one or more pan/tilt/zoom (PTZ) cameras, one or more fixed cameras with built-in infrared (IR) for nighttime imaging, or a combination thereof. For some embodiments, the satellite surveillance unit 110 may comprise any of various suitable devices for detecting sound and/or motion such as audio recorders, motion sensors (e.g., sensors employing lasers), infrared sensors, etc. Some embodiments may use surveillance devices suitable for use in harsh environments involving high humidity and/or extreme temperatures.

A conventional surveillance unit, comprising one or more surveillance devices, may typically find it difficult to monitor the area beyond an obstacle if the obstacle obscures or blocks the lines of sight of the surveillance devices. A construction site, for instance, may be filled with such obstacles, making monitoring of the site difficult. One way to solve this problem would be to deploy a plurality of conventional surveillance units in a manner that may facilitate monitoring of the areas surrounding these obstacles. However, the solution thus reached may not be power or cost efficient since the solution involves many surveillance units with individual power supplies. Furthermore, every surveillance unit may have to be provided with units for storing and processing collected data, causing additional overhead.

According to some embodiments of the invention, the satellite surveillance units 110 may be deployed in a manner that may overcome these limitations. For example, as illustrated in FIG. 1, mounting a satellite surveillance unit such as S₁ on a sidewall (or on the top or roof) of the structure 140 may facilitate monitoring of an area that a surveillance device at a different location on the construction site may not be able to monitor, especially if the structure 140 hinders the line of sight of the surveillance device. Similarly, satellite surveillance units 110 such as S₂, S₃ and S₄ may be deployed at other suitable locations on the construction site (e.g., on construction equipment, such as a crane 150, on or around structures/buildings under construction, etc.), as illustrated in FIG. 1, thus allowing these locations to be monitored, as well.

The satellite surveillance unit 110 may also comprise a transmitter 112 that may be configured to transmit the data collected by the surveillance devices 114 to the main server unit 120 using any of various suitable communication techniques. For example, some embodiments of the present disclosure may include high speed cellular, General Packet Radio Service (GPRS), Enhanced Data rates for Global Evolution (EDGE), satellite, Wi-Fi, WiMAX (Worldwide Interoperability for Microwave Access), mesh, and/or local area network (LAN) capabilities which the satellite surveillance units 110 and the main server unit 120 may use for communication purposes. The satellite surveillance unit 110 may transmit signals 130 in an effort to transfer information to the main server unit 120 as shown in FIG. 1. For some embodiments of the present disclosure, the data collected by a surveillance unit 110 may be transmitted continuously to the main server unit 120. In other embodiments, the collected data may be stored locally by the surveillance unit 110 and transmitted later or may be buffered.

Because the main server unit 120 may process and store the received data, the satellite surveillance unit 110 may be simple in construction, thereby consuming less power and costing less than conventional surveillance units. Accordingly, such satellite units 110 may contribute to reduced overall system cost. Since the main server unit 120 may centrally store the data collected by the satellite surveillance units 110, retrieval of the collected data may be easier.

The main server unit 120 may comprise a receiver 122 and one or more local surveillance devices 124 similar to the surveillance devices 114 of the satellite surveillance units 110. The receiver 122 may be configured to receive data from one or more remote satellite surveillance units 110 using any of various suitable communication techniques as described above.

### Example Satellite Surveillance Units

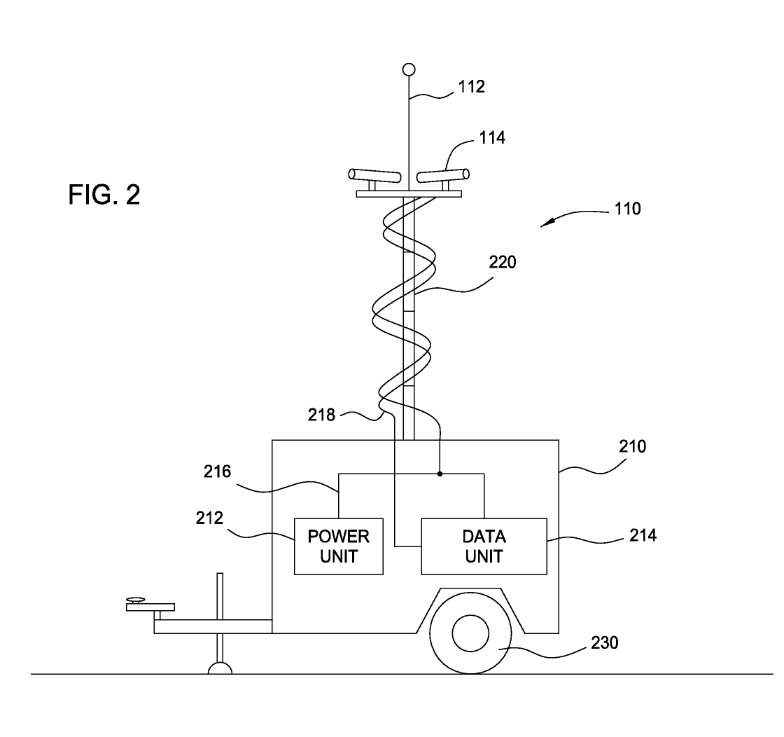

FIG. 2 illustrates a satellite surveillance unit 110 in greater detail in accordance with certain embodiments of the present disclosure. In addition to the transmitter 112 and the surveillance devices 114, the satellite surveillance unit 110 may comprise a mast or pole 220, a base unit 210, and/or wheels 230.

Certain embodiments of the present disclosure may provide means for supporting the surveillance devices 114 at a desired height above the base unit 210 in an effort to offer a clear or unobstructed view of a large surveillance area. For example, a mast or a pole, such as the pole 220 in FIG. 2, may support the surveillance devices 114 when mounted on the base unit 210. The pole 220 may be removable from or statically mounted on the base unit 210. For some embodiments, the pole 220 may have a fixed length. For other embodiments, the pole 220 may be a telescoping structure that may allow the height of the surveillance devices 114 to be adjusted. For example, a galvanized three-section telescoping pole with adjustable height (e.g., from 6 feet to 25 feet, or 1.83 m to 7.62 m) may be used. The means for telescoping the pole 220 may include electric winches, air cables, manual winches, a twist lock, etc. For example, the height of the pole may be adjusted using a dual winch system. In some embodiments, the pole 220 may comprise an eyelet for raising the pole 220.

Some embodiments may comprise means for raising, lowering, or otherwise positioning the pole 220. For example, a hinge mechanism may be provided to allow the pole 220 to rotate between an approximately upright position for surveillance and a fully or at least a more prone position for transportation. For other embodiments, the pole 220 may not be hinged. For such embodiments, the pole 220 may be stepped in a block or other fixture on the base unit 210 in an effort to conduct surveillance. When the surveillance equipment is not in use, the pole 220 may be dismounted (i.e., removed from the block or other such fixture) and lowered to facilitate transportation and/or deployment.

The base unit 210 of the satellite surveillance unit 110 may comprise a power unit 212 and a data unit 214. The power unit 212 may comprise means for providing power to the surveillance devices 114 and the rest of the satellite surveillance unit 110. For some embodiments, the power unit 212 may comprise means for receiving power from one or more external power sources (e.g., power from power lines of an electric grid, stepped down by a transformer). In other embodiments, the power unit 212 may comprise one or more batteries that may act as a stand-alone power source, or may be used together with power from external power sources for powering the satellite surveillance unit 110. The power unit 212 may provide power to the surveillance devices 114 and the rest of the satellite surveillance unit 110 including the data unit 214 via one or more power cables 216.

In certain embodiments, the power unit 212 may comprise a chargeable power source, a charging power source, and one or more components for controlling charging of the chargeable power source. The chargeable power source may be configured to power the components of the satellite surveillance unit 110. The chargeable power source may be any of various suitable devices capable of being repeatedly recharged and supplying sufficient power. In some embodiments, the chargeable power source may comprise one or more rechargeable batteries. Any of various types of rechargeable batteries may be used. For example, the chargeable power source may comprise one or more gel batteries (also known as gel cells), which contain battery acid in a gel form. For other embodiments, the chargeable power source may comprise other types of lead-acid batteries, such as one or more absorbent glass mat (AGM) lead-acid batteries. The terminals of the chargeable power source may be connected with the surveillance devices 114 and the data unit 214 via the power cable 216 in an effort to provide power to the components of the satellite surveillance unit 110.

The charging power source may provide means to charge the chargeable power source. The charging power source may comprise any of various suitable power sources, such as generators that may convert mechanical energy into electrical energy, solar cells that may convert solar energy into electrical energy, etc., used alone or in combination. For some embodiments, the charging power source may comprise an engine driving an alternator to charge the chargeable power source, similar to the engine/alternator/battery combination in a modern automobile. For other embodiments, the charging power source may comprise an engine-generator set (gen-set), which is the combination of an engine driving an electrical generator. The engine of the gen-set may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system. In the embodiments of charging power sources having an engine described above, the chargeable power source or a separate source (e.g., a battery) may provide power to a starter motor for powering on the engine.

For still other embodiments, the charging power source may comprise a gas engine generator (GEG) where the mechanical energy powering the electrical generator is heat energy from the burning of a gas. For example, the gas burned in a GEG may be natural gas or propane (liquid or gas).

As the efficiency of solar cells continues to improve, the charging power source may comprise one or more solar panels in some embodiments. Each solar panel may comprise several solar cells and may be mounted on an upper or angled lateral surface of the satellite surveillance unit 110.

The data unit 214 may comprise means for locally storing the data collected by the surveillance devices 114. For example, in some embodiments, the data unit 214 may comprise any of various suitable storage devices such as a hard disk, magnetic tape, Random Access Memory (RAM), flash memory, etc. The collected data may be carried to the data unit 214 via one or more signal cables 218. Data stored in the data unit 214 may be retrieved later or sent to the transmitter 112 via the signal cables 218, to be transmitted to the main server unit 120.

In some embodiments of the present disclosure, the base unit 210 may further comprise a control unit for controlling the surveillance devices 114. For example, such control operations may include panning, tilting, or zooming operations of one or more cameras composing the surveillance devices 114. Control signals may be carried from the data unit 214 to the surveillance devices 114 via the signal cable(s) 218. For some embodiments, one or more control signal cables, separate from the signal cable(s) 218, may be used for this purpose.

In some embodiments of the present disclosure, the satellite surveillance units 110 may comprise means to facilitate transportation and/or deployment of these units. For example, a trailer assembly with wheels 230 as depicted in FIG. 2 may be used. Such a trailer assembly may comprise any of various suitable components for transporting and/or operating the satellite surveillance unit 110. These may include any combination of the following: rear outriggers, a tongue jack, a lifting eye, taillights, etc. Some embodiments may use a sturdy trailer assembly that may be operational in wind gusts up to about 65 mph (104.6 kilometers per hour). For example, the trailer assembly may comprise rear outriggers for stabilizing the structure during strong wind gusts or when placed on an uneven surface.

For some embodiments the wheels 230 may be eliminated altogether or replaced with arrangements such as skids, skis or sleds, legs, etc., in order to facilitate transportation/deployment of the satellite surveillance units 110 using such arrangements if available. Transportation of the units 110 to locations not accessible by road, or when the roads leading to a location are not usable due to inclement weather conditions involving ice, snow, etc., may be made easier by these arrangements. Certain embodiments may provide means for supporting the satellite surveillance unit 110 above a surface (e.g., up off the ground) and/or for stabilizing the unit 110. For example, the satellite surveillance unit 110 may include legs comprising outriggers or other types of stabilizers.

As another example, certain satellite surveillance units 110, such as units S₁ and S₄ shown in FIG. 1, may comprise means for mounting these units on a surface, such as a wall. For some embodiments, a surface-mountable satellite surveillance unit may have a mounting unit comprising components similar in structure and function to the components within the base unit 210 (e.g., the power unit 212 and the data unit 214).

In some embodiments of the present disclosure, the satellite surveillance unit 110 may not include the data unit 214. In such embodiments, the satellite surveillance unit 110 may simply comprise means for powering the satellite surveillance unit 110, such as the power unit 212, and means for transmitting data collected by the satellite surveillance unit 110, such as the transmitter 112. In such embodiments, transmission of the data collected by the surveillance devices 114 to the main server unit 120 may be continuous. By not including the data unit 214 in the satellite surveillance units 110, cost, volume, and effort involved in data storage and retrieval may be saved. Data collected by the satellite surveillance units 110 may be centrally stored in the main server unit 120 alone, making retrieval and processing of the collected data easier.

### An Example Main Server Unit

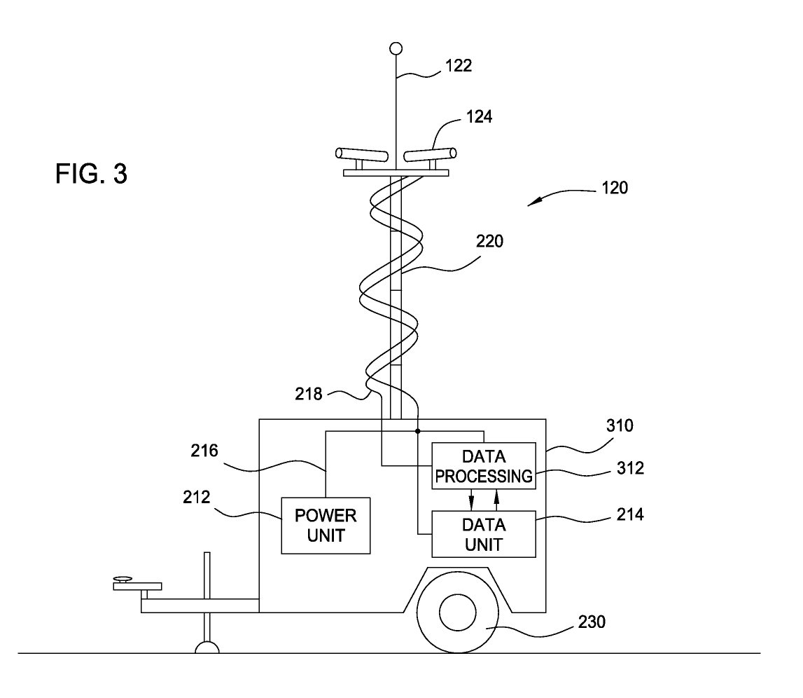

FIG. 3 illustrates a main server unit 120 in accordance with certain embodiments of the present disclosure. Certain embodiments of the main server unit 120 may include one or more components similar in structure and function to certain components of the satellite surveillance unit 110. As illustrated in FIG. 3, the main server unit 120 may comprise a receiver 122, a mast or pole such as the pole 220 in FIG. 2, a base unit 310 and wheels such as the wheels 230 described in FIG. 2. The main server unit 120 may be deployed at a convenient location on a site or installation to be surveyed or at a remote location (e.g., monitoring facilities, etc.).

The receiver 122 may be configured to receive data from one or more remote satellite surveillance units 110 using any of various suitable communication techniques as described earlier. Depending on the communication technique used, in some embodiments, the main server unit 120 may include state-of-the-art communication capabilities (e.g., acknowledging correct reception of data, requesting retransmission if the data was not properly received, etc.).

In certain embodiments, in addition to receiving data from the satellite surveillance units 110, the main server unit 120 may monitor and collect data about the location at which the main server unit 120 is deployed and the surrounding area. The main server unit may comprise one or more local surveillance devices 124 that may be used for this purpose. The local surveillance devices 124 may be similar in structure and function to the surveillance devices 114 of the satellite surveillance units 110 illustrated in FIG. 1. Accordingly, any of various suitable surveillance devices like cameras, audio recorders, motion sensors, etc., may be used. Other embodiments of the main server unit 120 may not include the local surveillance devices 124.

As depicted in FIG. 3, the base unit 310 may comprise components similar in structure and function to the components of the base unit 210 illustrated in FIG. 2. In addition to being able to carry data from the local surveillance devices 124 to the data unit 214, signal cable(s) 218 of the main server unit 120 may also carry data from the receiver 122 to the data unit 214. Besides these components, the base unit 310 may include a data processing unit 312.

The data processing unit 312 may comprise means for performing various data processing functions. For example, in embodiments that include surveillance devices like video cameras, the data processing unit may comprise means for performing video processing functions such as video recording, image processing, time stamping, and video encoding. Accordingly, the data processing unit 312 may comprise devices such as digital video recorders (DVRs), videocassette recorder (VCRs), encoders, etc., which may be configured to perform these functions. In some embodiments, the data processing unit 312 may comprise personal computers (PCs), workstations, etc., for increased processing capabilities.

Some embodiments of the main server unit 120 may include means for transmitting collected data and/or processed results from the data processing unit 312 to a remote unit (not shown) (e.g., remote servers, PCs, workstations, etc.). For example, mechanisms such as antennas, transmitters, etc., may be used to achieve this. Doing so may facilitate further processing and/or monitoring at a remote location. Any of various suitable techniques such as the ones previously described for the transmitter 112 of the satellite surveillance unit 110 may be used by the main server unit 120 to transmit data to the remote unit.

Certain embodiments of the main server unit 120 may not include the pole 220 or the local surveillance devices 124. According to these embodiments, the main server unit 120 may simply receive data from the satellite surveillance units 110 and perform data processing and storage without monitoring any part of the area where the main server unit 120 is positioned. In such instances, the transmitter may be mounted to or part of the base unit 310.

For some embodiments of the main server unit 120, the wheels 230 may be eliminated altogether or replaced with means such as skids, skis or sleds, legs, etc., similar to the arrangements described earlier regarding the satellite surveillance unit 110. These arrangements may offer similar advantages.

The security system 100 may include one or more alarms and means for activating the alarms. For example, a motion detector composing the surveillance equipment of a satellite surveillance unit 110 or the main server unit 120 may be coupled with an audible or silent alarm to trigger the alarm when unauthorized or unexpected motion at the installation site is detected after hours or on weekends, for example. For some embodiments, the system 100 may comprise means for activating a remote siren that may be mounted away (e.g., at a remote monitoring station) from the rest of the security system. For some embodiments, the alarm may trigger a flood light or spot light to turn on in an effort to deter trespassers and/or assist the camera(s) with imaging, especially at night. Components of the security system 100 may include global positioning system (GPS) tracking for increased functionality and traceability.

For some embodiments, a satellite surveillance unit 110 or the main server unit 120 may send an e-mail, text message (Short Message Service, or SMS), or a paging notification to a remote site, PC, server, or mobile device whenever an alarm has been triggered in an effort to alert someone. This message may include a video and/or one or more camera snapshots of the monitored site starting from when the alarm was triggered or shortly thereafter.

### Monitoring a remote site

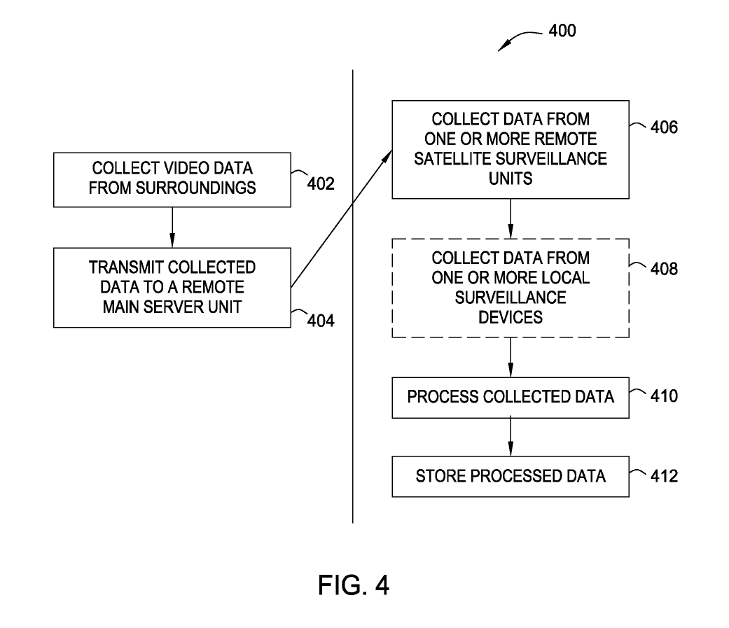

Different techniques may be used for monitoring a remote installation or site using the security system 100 provided by the current disclosure. FIG. 4 illustrates example operations 400 for monitoring a remote installation or site in accordance with certain embodiments of the present disclosure. The operations on the left side of the flow chart may be performed by one or more satellite surveillance units, such as the satellite surveillance units 110 shown in FIG. 1. The operations on the right side of the flow chart may be performed by a main server unit, such as the main server unit 120 shown in FIG. 1. As described earlier, these units may use any of various suitable techniques for communication. The units may transmit and/or receive data and control information accordingly.

The operations 400 may begin at 402 with the satellite surveillance unit 110 collecting video data from surroundings. The surveillance devices 114 of the satellite surveillance unit 110 may comprise one or more video cameras which may be used for this purpose.

At 404, the satellite surveillance unit 110 may transmit the collected data to the main server unit 120. This may be achieved by using a transmitter such as the transmitter 112 and a signal such as the signal 130 to send the data to the main server unit 120.

At 406, the main server unit 120 may collect the data transmitted by the satellite surveillance units 110. To achieve this, the main server unit 120 may use a receiver such as the receiver 122 shown in FIG. 1. Depending on the communication technique used, actions such as acknowledgement of received data, requesting retransmission of data, etc., may also be performed by the main server unit 120, at 406. Retransmission of data by the satellite surveillance units 110 may ensure that the received data is free from error.

At 408, for some embodiments, the main server unit 120 may collect data from one or more local surveillance devices 124 as shown in FIG. 3. For example, this may involve collecting video data if the surveillance devices 124 comprise video cameras. At 410, the main server unit 120 may process the data collected from remote satellite surveillance units 110 (and the local surveillance devices 124). To achieve this, the main server unit 120 may use a data processing unit such as the data processing unit 312 shown in FIG. 3, which may provide means for performing data processing functions. For example, in some embodiments, the data processing unit 312 may comprise devices like video recorders, encoders, etc., that may be configured to perform different video processing functions.

At 412, the main server unit 120 may store the processed data. This may be accomplished by using local storage such as the data unit 214 shown in FIG. 3. In some embodiments, in addition to storing the processed data locally, the main server unit 120 may transmit the processed data to a remote monitoring station or facility. In such embodiments, the main server unit may comprise means for performing the transmission, such as a transmitter and an antenna.

While the foregoing is directed to embodiments of the present invention, other and further embodiments of the invention may be devised without departing from the basic scope thereof, and the scope thereof is determined by the claims that follow.

1. A system for surveillance, comprising:
a main unit, comprising:
a receiver; and
a data processing unit configured to process signals received by the receiver; and
one or more satellite units, wherein at least one of the satellite units comprises:
a pole;
satellite surveillance equipment mounted on the pole; and
a transmitter configured to transmit signals from the satellite surveillance equipment to the receiver of the main unit for processing.

2. The system of claim 1, wherein the pole is a telescoping pole.

3. The system of claim 1, wherein the pole is removable from the at least one of the satellite units.

4. The system of claim 1, wherein the main unit comprises local surveillance equipment, such that the data processing unit is configured to process signals from the local surveillance equipment and the signals received by the receiver.

5. The system of claim 4, wherein the local surveillance equipment is mounted on a pole of the main unit.

6. The system of claim 5, wherein the pole of the main unit is a telescoping pole.

7. The system of claim 1, wherein the satellite surveillance equipment comprises at least one of a camera, a motion sensor, an infrared (IR) sensor, a laser, a light, and an alarm.

8. The system of claim 1, wherein the data processing unit is a video processing unit for processing the signals received by the receiver and wherein the signals represent images.

9. The system of claim 1, wherein the at least one of the satellite units comprises means for transporting the at least one of the satellite units.

10. The system of claim 9, wherein the means for transporting comprises a trailer assembly with wheels.

11. The system of claim 1, wherein the transmitter is configured to wirelessly transmit the signals from the satellite surveillance equipment.

12. The system of claim 11, wherein the transmitter is configured to transmit the signals from the satellite surveillance equipment using at least one of high speed cellular, General Packet Radio Service (GPRS), Enhanced Data rates for Global Evolution (EDGE), satellite, Wi-Fi, or WiMAX (Worldwide Interoperability for Microwave Access).

13. The system of claim 1, wherein another one of the satellite units is mounted on a roof or a sidewall of a structure.

14. The system of claim 1, wherein another one of the satellite units is mounted on construction equipment.

15. A system for surveillance, comprising:
a main unit, comprising:
a pole;
local surveillance equipment mounted on the pole;
a receiver; and
a data processing unit configured to process signals from the local surveillance equipment and signals received by the receiver; and
one or more satellite units, wherein each of the satellite units comprises:
satellite surveillance equipment; and
a transmitter configured to transmit signals from the satellite surveillance equipment to the receiver of the main unit, wherein the data processing unit of the main unit is configured to process the signals from the satellite surveillance equipment.

16. The system of claim 15, wherein the pole is a telescoping pole.

17. The system of claim 15, wherein the pole is removable.

18. The system of claim 15, wherein the local surveillance equipment or the satellite surveillance equipment comprises at least one of a camera, a motion sensor, an infrared (IR) sensor, a laser, a light, and an alarm.

19. The system of claim 15, wherein the main unit comprises means for transporting the main unit.

20. The system of claim 19, wherein the means for transporting comprises at least one of a sled, a skid, or two or more skis.

21. The system of claim 15, wherein the data processing unit is a video processing unit for processing the signals from the local surveillance equipment and the signals received by the receiver representing images.

22. The system of claim 15, wherein at least one of the satellite units is mounted on a sidewall of a structure.

23. The system of claim 15, wherein at least one of the satellite units is mounted on construction equipment.

24. The system of claim 23, wherein the construction equipment comprises a crane.

25. The system of claim 15, wherein the transmitter is configured to wirelessly transmit the signals from the satellite surveillance equipment.

26. The system of claim 25, wherein the transmitter is configured to transmit the signals from the satellite surveillance equipment using at least one of high speed cellular, General Packet Radio Service (GPRS), Enhanced Data rates for Global Evolution (EDGE), satellite, Wi-Fi, or WiMAX (Worldwide Interoperability for Microwave Access).
